(19) United States
(12) Patent Application Publication
(10) Pub. No.: US 2026/0095437 A1
(43) Pub. Date: Apr. 2, 2026

(54) AUTOMATED VIRTUAL PRIVATE NETWORK SESSION ROUTING

(71) Applicant: FMR LLC, Boston, MA (US)

(72) Inventors: Syed Muzamil, Bengaluru (IN); Palavalli Govindaraju Raghunandan, Bangalore (IN); Hari Balaji Srinivasan, Chennai (IN)

(21) Appl. No.: 18/902,098

(22) Filed: Sep. 30, 2024

(51) Int. Cl. H04L 9/40; H04L 49/60

(52) U.S. Cl. CPC H04L 63/0272; H04L 49/602

(57) ABSTRACT

A computerized method is provided for automated routing of active virtual private network sessions. Methods can include modules to actively monitor, through periodic polling, internal connections to remote resources for the site of a VPN appliance. Upon detecting sufficiently impaired connectivity via the internal connection, the VPN connections optimization tool can automatically disable the external interface on affected VPN appliances to force disconnections of VPN clients and rerouting to available VPN appliances with functioning internal links.

### TECHNICAL FIELD

This application relates generally to systems, methods, and apparatuses, including computer program products, for automated routing of virtual private network (VPN) sessions.

### BACKGROUND

Virtual private networks (VPN) allow for secure connections between computing devices and networks across an insecure network. In the current era of remote working, VPNs are increasing prevalent and vital to productivity and continuity as workers move between home and office. VPNs can also be used to connect an organizations network infrastructure across geographic locations including between different international sites. The VPN infrastructure is often set up to optimize performance by prioritizing connection to the nearest available appliances in the region based on geographic location.

Another technology used in telecommunications networks is multiprotocol label switching (MPLS). MPLS is a routing technique that directs data from one node to the next based on labels rather than network addresses. Unfortunately, in certain network setups, if an MPLS or other internal link for a site fails, VPN clients connected to a VPN at that site can lose access to remote resources relying on the internal link (e.g., internal applications hosted at other sites). The VPN appliance may not generally recognize such issues and therefore a VPN client can be stuck without access to needed resources and may require manual rerouting which can prove costly and time intensive in large organizations.

### SUMMARY

Systems and methods described herein provide for automated VPN session routing that address the issue noted above. A VPN connection optimization tool can be employed in each VPN appliance location to monitor the status of any internal link that the site relies on to access other sites. That monitoring can be accomplished through periodic polling and whenever the link goes down or becomes significantly impaired or unreachable, the VPN connection optimization tool can automatically disconnect all active users from the affected VPN appliances and re-direct them to other available VPN appliances nearby with healthy MPLS or other internal links.

The systems and methods of the invention provide the benefit of reduced down time for isolated users. Manual redirection of each VPN client can take up to twenty mins per device, and that is only after the user notices and reports the problem. The automated VPN session routing tools described herein can reduce that rerouting time to a few minutes and due to constant background monitoring, may detect and correct issues before a user even notices.

Systems and methods of the invention can poll their local link and when the link is unresponsive for a selectable threshold (e.g., 2 minutes), can initiate the remedial action automatically by logging in to all the affected VPN appliances and forcibly disabling the external interface of the appliance to disconnect the active VPN sessions and re-route them to other available VPN appliances.

Aspects of the invention can include methods for routing virtual private network (VPN) sessions, the methods comprising: providing a computer network data center comprising a plurality of zones, each zone comprising a VPN connections optimization tool and one or more VPN appliances operable to securely connect a VPN client to the data center. Each zone can be connected to one or more remote resources by a multiprotocol label switching (MPLS) link. The VPN connections optimization tool at a first zone can be operable to perform the steps of: periodically polling availability of a first zone's MPLS link; receiving a threshold number of consecutive network down responses in response to the periodic polling; and subsequently initiating a VPN connections failover process.

The VPN connections failover process can include logging into the one or more VPN appliances at the first zone and disabling an external interface thereof using the VPN connections optimization tool at the first zone. The disabling step can trigger the VPN clients connected to the one or more VPN appliances at the first zone to reconnect to a second VPN appliance connected to the one or more remote resources via an internet connection. In certain embodiments, the second VPN appliance may be in a second zone in the computer network data center. The one or more VPN appliances at the first zone can connect to the second VPN appliance in the second zone via an MPLS connection.

In some embodiments, the second VPN appliance can be in a zone in a second computer network data center. The one or more VPN appliances at the first zone can connect to the second VPN appliance in the zone in the second computer network data center via an internet connection. The periodically polling step can occur every 15 seconds or less. The threshold number of consecutive network down responses can comprise at least 6. In various embodiments, the computer network data center may be one of a plurality of computer network data centers located at a plurality of geographically distributed sites.

In certain aspects, systems of the invention can include a computer system for routing virtual private network (VPN) sessions. Systems can comprise a computer network data center comprising a plurality of zones, wherein each zone comprises a VPN connections optimization tool and one or more VPN appliances operable to securely connect VPN clients to the data center. Each zone may be connected to one or more remote resources by a different multiprotocol label switching (MPLS) link and the VPN connections optimization tool at a first zone can be operable to perform the steps of: periodically polling the first zone's MPLS link's availability; receiving a threshold number of consecutive network down responses in response to the periodic polling; and subsequently initiating a VPN connections failover process after the receiving step.

In various embodiments systems of the invention can be operable to perform any and all of the aforementioned methods.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for automated routing of active VPN sessions.

FIG. 2 shows an exemplary method for automated routing of active VPN sessions.

FIG. 3 shows exemplary network architecture for automated routing of active VPN sessions.

FIG. 4 shows an exemplary workflow for automated routing of active VPN sessions.

FIG. 5 shows an exemplary system for automated routing of active VPN sessions in a multisite network with functioning MPLS connections to remote resources.

FIG. 6 shows an exemplary system for automated routing of active VPN sessions in a multisite network rerouting VPN connections from a site with failed MPLS connections to remote resources.

### DETAILED DESCRIPTION

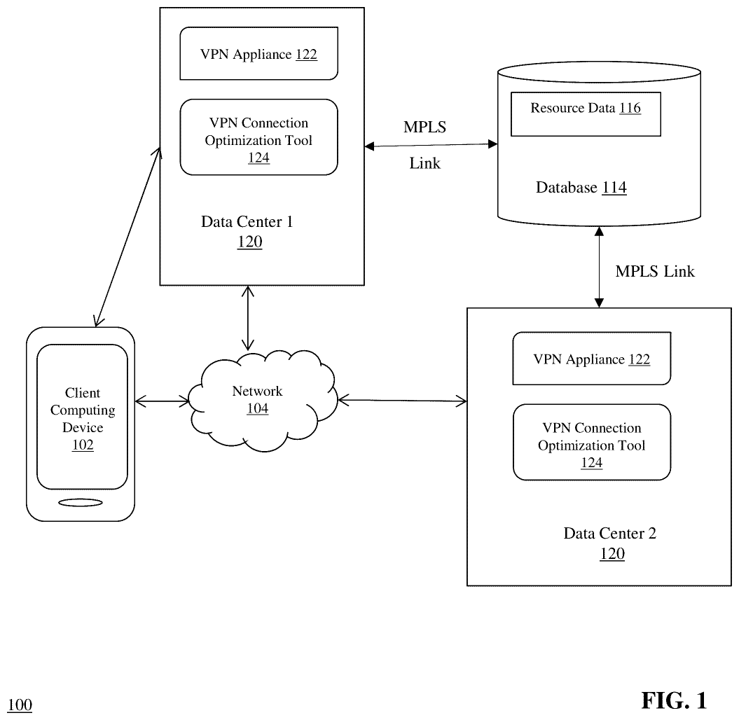

FIG. 1 is a block diagram of an exemplary system 100 for automated routing of VPN sessions. The system 100 includes a client computing device 102, a communications network 104, multiple data centers 120 that include a VPN appliance 122 through which the client computing device 102 connects to the data center 120 and a VPN connection optimization tool 124, and a database 114 that includes resource data 116 and remote applications. The database, including various remote applications and resource data 116 are accessible from the data centers 120 via multiprotocol label switching (MPLS) links

The client computing device 102 and the data centers 120 are connected to one or more communications networks (e.g., network 104) in order to communicate with each other. Connections between the client computing device 102 and any data center 120 are securely managed by VPN and orchestrated by the VPN appliance in a given data center 120.

Exemplary client computing devices 102 include but are not limited to server computing devices, desktop computers, laptop computers, tablets, mobile devices, smartphones, and the like. Typically, the client computing device 102 includes a display device (not shown) that is embedded in and/or coupled to the client computing device for the purpose of displaying information to a user of the device. It should be appreciated that other types of computing devices that are capable of connecting to the components of the system 100 can be used without departing from the scope of invention. Although FIG. 1 depicts one client computing device 102, it should be appreciated that the system 100 can include any number of client computing devices.

In some embodiments, the client computing device 102 can execute one or more software applications that are used to provide input to and receive output from resources stored at the data centers 120 or in the database 114. For example, the client computing device 102 can be configured to execute one or more native applications and/or one or more browser applications. Generally, a native application is a software application (in some cases, called an ‘app’) that is installed locally on the client computing device 102 and written with programmatic code designed to interact with an operating system that is native to the client computing device 102. Such software may be available from, e.g., the Apple® App Store, the Google® Play Store, the Microsoft® Store, or other software download platforms depending upon, e.g., the type of device used. In some embodiments, the native application includes a software development kit (SDK) module that is executed by a processor of the client computing device 102 to perform functions (e.g., enter or approve time worked or request time off). Generally, a browser application comprises software executing on a processor of the client computing device 102 that enables the client computing device to communicate via HTTP or HTTPS with remote servers addressable with URLs (e.g., server computing device 106) to receive website-related content, including one or more webpages, for rendering in the browser application and presentation on the display device coupled to the client computing device 102. Exemplary mobile browser application software includes, but is not limited to, Firefox™, Chrome™, Safari™, and other similar software. The one or more webpages can comprise visual and audio content for display to and interaction with a user.

The communications network 104 enables the client computing device 102 to communicate with the data centers 120. The network 104 is typically comprised of one or more wide area networks, such as the Internet and/or a cellular network, and/or local area networks. In some embodiments, the network 104 is comprised of several discrete networks and/or sub-networks (e.g., cellular to Internet).

In various embodiments, the data centers 120 can comprise one or more server computing devices. Server computing devices can include specialized hardware and/or software modules that execute on a processor and interact with memory modules of the server computing device to receive data from other components of the system 100, transmit data to other components of the system 100, and perform functions. The data centers 120, the databases 114, and/or any number of remote resources connected to the data centers 120 via internal links such as MPLS links can include resource data 116 and any number of programs that may execute on the processor of the data center 120 or the remote resource and may each, despite being disparate programs, rely on a regular exchange of data between them. In some embodiments, such programs may be specialized sets of computer software instructions programmed onto one or more dedicated processors in a server computing device and can include specifically designated memory locations and/or registers for executing the specialized computer software instructions.

It should be appreciated that any number of computing devices, arranged in a variety of architectures, resources, and configurations (e.g., cluster computing, virtual computing, cloud computing) can be used without departing from the scope of the invention.

In some embodiments, all or a portion of the database 114 can be integrated with a server computing device or be located on a separate computing device or devices. The database 114 can comprise one or more databases configured to store portions of data used by the other components of the system 100.

As shown in FIG. 1, in order to maintain network security all access to the resource data 116 or other organizational resources is managed via internal links such as MPLS links. The various databases 114, other remote resources, and data centers 120 can be located at discrete locations that may be separated geographically across the globe. The MPLS links can aid in secure, reliable, and fast access to centralized resources from various locations which can be especially useful in an international organization with multiple sites around the world. The client computing device 102 can only access the remote resources such as the resource data 116 via a data center 120 and its MPLS link and the client computing device can only access the data centers 120 by a VPN appliance 122 managing a VPN connection. Should the VPN appliance 122 fail, the client computing device 102 would generally seek another connection with existing solutions. However, a standard VPN appliance 120 is generally blind to the health of internal links such as the MPLS link in the system 100 shown in FIG. 1. Accordingly, should a data center's 120 MPLS link to a remote resource fail, the client computing device would lose access to any remote resources but the VPN connection would be maintained. A user would have to identify their lack of connectivity and a network administrator would have to manually reset their VPN connection so that they could reconnect to a different data center 120 with a functional MPLS link through the network 104 and that data centers 120 VPN appliance 122. In systems and methods of the present invention, however, a VPN connection optimization tool 124 present in each data center 120 actively monitors the internal networks and/or any other downstream connections and, upon detection of a failure or impairment beyond a selected threshold, the VPN connection optimization tool 124 can automatically disconnect the client computing device 102 from the VPN appliance 122 at the data center 120 with the faulty MPLS link so that the client computing device 102 can reconnect to a different VPN appliance 122 at a different data center 120.

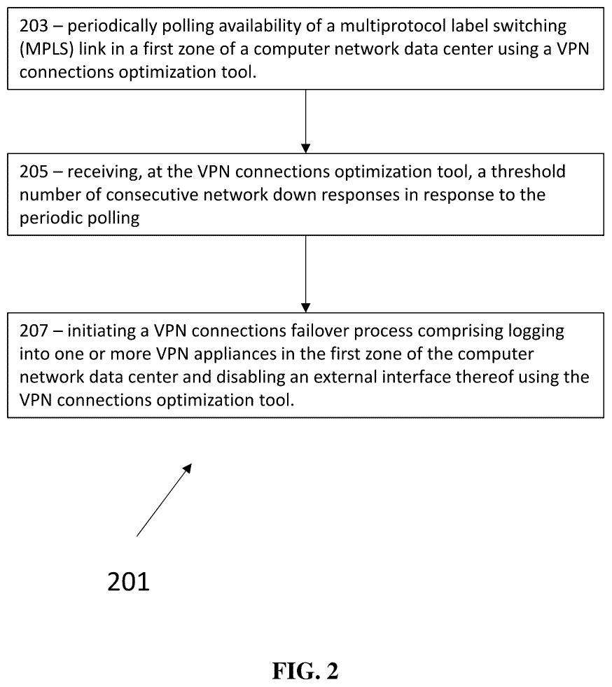

FIG. 2 shows an exemplary method 201 for automated routing of VPN sessions. A VPN connections optimization tool in a first zone of a computer network data center periodically polls 203 availability of an MPLS link from that first zone to a remote resource or other device or system. The polling period can be selected by an administrator and may be every 15 minutes or less, 10 minutes or less, 5 minutes or less, 1 minute or less, 30 seconds or less, 15 seconds or less, 5 seconds or less, or 1 second or less. Polling periods can be selected to balance rapid detection of network failures with stress on system resources.

The VPN connections optimization tool can then receive 205 a threshold number of consecutive network down responses in response to the periodic polling. The network down response can be a complete lack of connectivity or responsiveness to the polling of may be a response that is below a threshold latency or otherwise does not meet threshold performance benchmarks. The various thresholds can be set by a system administrator via a user interface with the VPN connections optimization tool. In various embodiments, the threshold number of consecutive network down responses can be 2, 3, 4, 5, 10, 15, 20, 25 or more. Receipt of a response indicating a healthy network connection can rest the count as network down responses before and after the healthy indication would not be consecutive. In various embodiments, receiving a threshold number of network down responses, even non-consecutively, in a given time period may trigger a failover process. For example, if more than 5%, 10%, 15%, 25%, 50%, or 75% of periodic polling responses in a given time frame such as a minute, 5 minutes, 15 minutes, 30 minutes, or an hour are indicative of a failed MPLS link, the system may initiate a failover regardless of whether the network down responses were consecutive.

Upon receiving 205 the threshold number of consecutive network down responses, the VPN connections optimization tool can initiate 207 a VPN connections failover process comprising logging into one or more VPN appliances in the first zone of the computer network data center and disabling an external interface thereof.

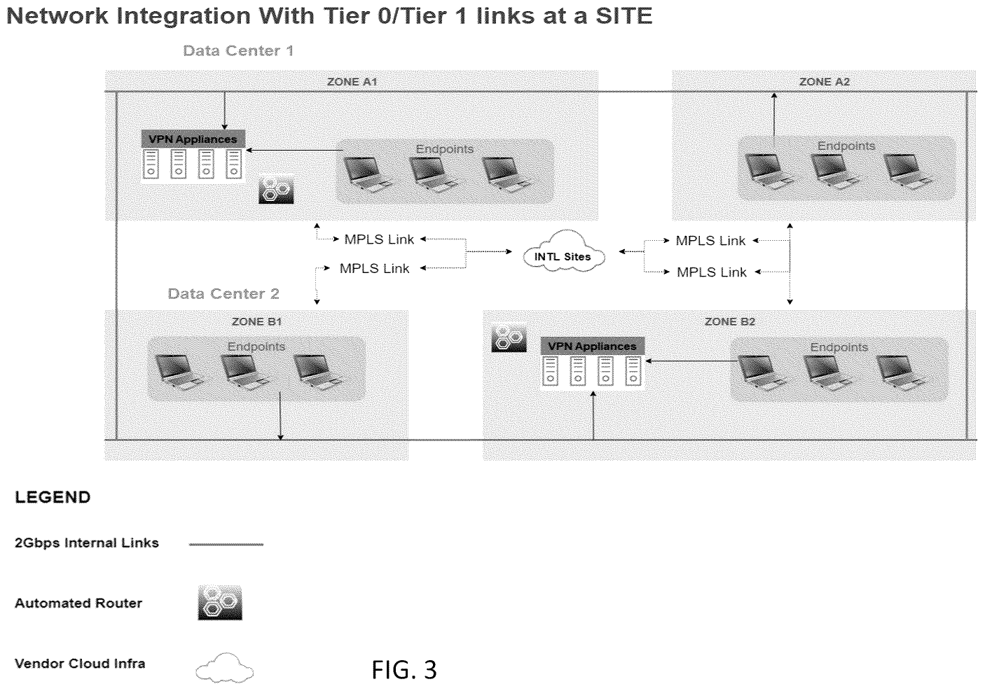

FIG. 3 shows an exemplary network architecture featuring an automated VPN connections optimization tool. The illustrated network setup may apply to a multi-site international organization where each site has two or more datacenters and each datacenter has two or more zones. VPN appliances are present in each zone that manage VPN connections and act as gatekeepers. MPLS links connect the zones in the data centers to international sites and their reliability is therefore crucial for communication. The VPN connections optimization tool present in each zone continuously monitors MPLS link health. In some embodiments, the optimization tool can poll every 15 seconds to check MPLS link health/availability. If the polling fails for 6 iterations, for example, the tool can automatically act and initiate active VPN connections failover processes.

The failover mechanism can consist of the VPN connections optimization tool logging into the VPN appliance and disabling the external interface of the affected VPN appliances. That action can trigger the VPN client on any connected endpoint devices to reconnect using their VPN connection protocol to the next available VPN appliance. Because any VPN appliances with unhealthy MPLS links will have had their external interfaces disabled, the client will automatically connect, via the internet generally, to the first functioning VPN appliance in a zone with a healthy MPLS link that otherwise meets the VPN client's requirements. The MPLS links are connected via cloud infrastructure such as those available from Verizon Communications Inc., New York, NY or AT&T Inc., Dallas, TX.

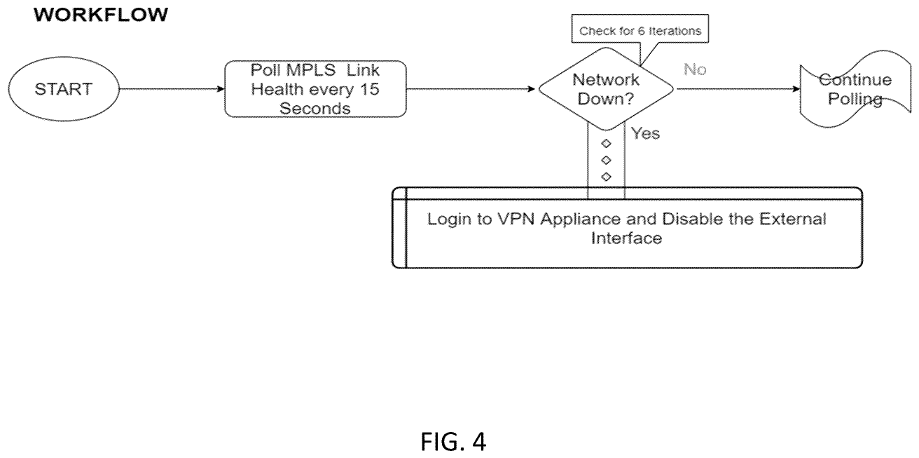

FIG. 4 shows an exemplary workflow for an automated VPN connections optimization tool. The tool polls the local MPLS link health every 15 seconds. If the network is down for six consecutive polling iterations, then the tool logs into the VPN appliance and disables the external interface. If the network polling returns a healthy indication, then polling continues every 15 seconds.

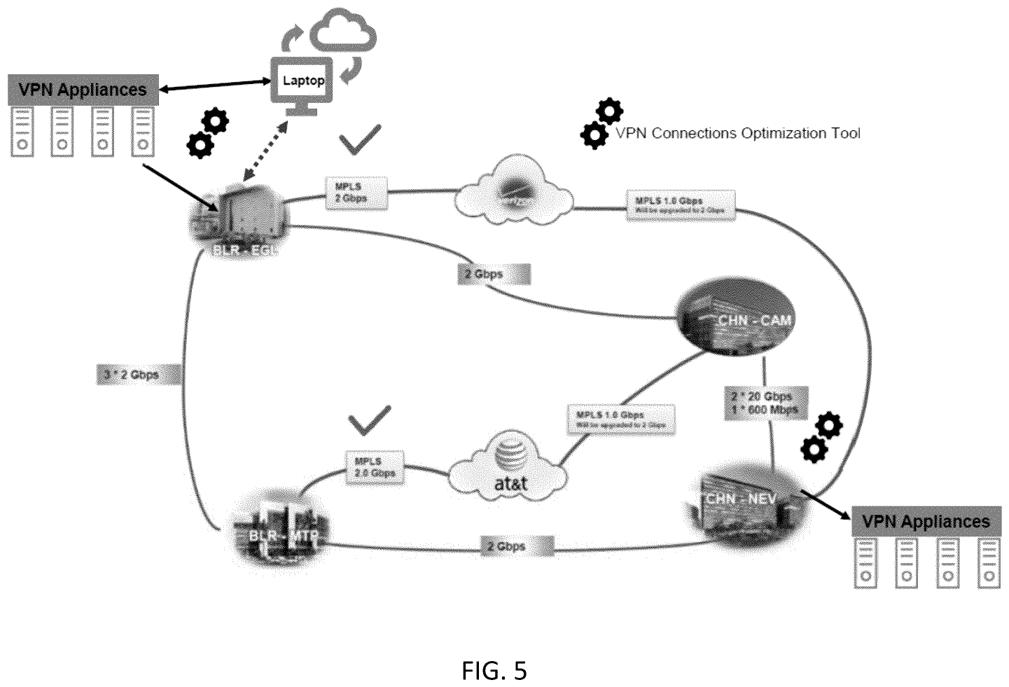

FIG. 5 illustrates an exemplary organizational network architecture featuring a VPN connections optimization tool while the MPLS links for a given region are healthy.

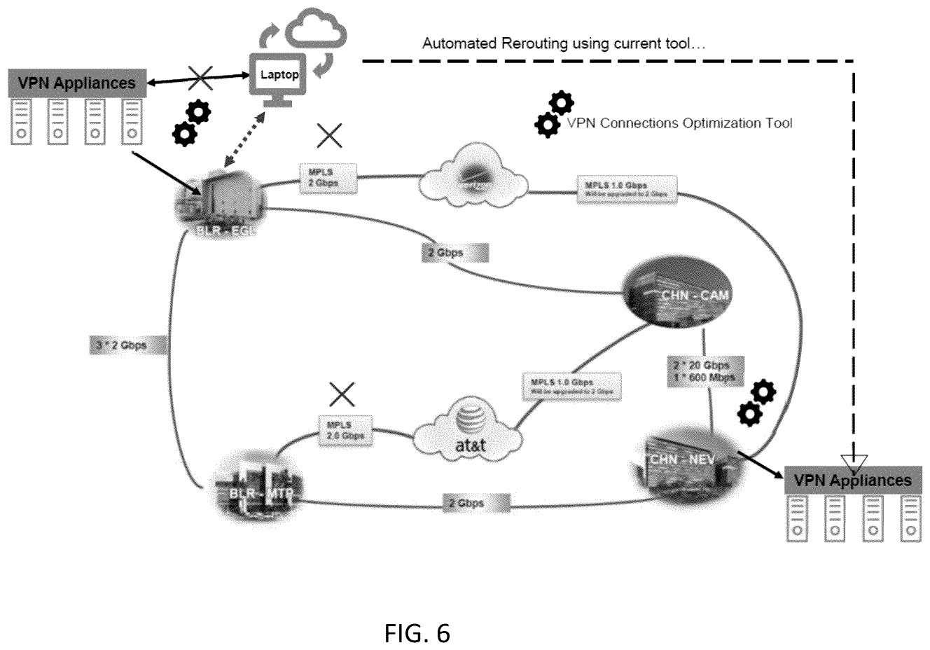

As pictured, there are two regions, Bangalore (BLR) and Chennai (CHN) with each region having two datacenters (EGL and MTP Bangalore and CAM and NEV in Chennai). Users, as indicated by the laptop in FIGS. 5 and 6 are connected to the VPN appliances in a datacenter within the region.

In the depicted architecture, the user is connected via the VPN appliance at the EGL data center in Bangalore. The two data centers in each region are in communication with each other via an internal link and each data center is in communication with remote resources via an MPLS link. When one internal network link breaks within a datacenter (e.g., the BLR-EGL link), there is redundancy built in based on the MPLS link of the other, linked data center in that region (e.g., the BLR-MTP MPLS link) so the VPN appliance in BLR-EGL is able to maintain a connection for the client laptop to remote resources via the BLR-MTP MPLS link. However, when all of the MPLS links fail in a region, the datacenter of the entire region is then isolated from the external network.

In this scenario VPN users connected to that datacenter/region will not have access to many internal applications/resources and sites that are connected via the MPLS links. To gain full access, all the affected user's active VPN session must be disconnected and rerouted to other VPN appliances in other regions.

Such an instance is depicted in FIG. 6. Both MPLS links are down and the VPN connections optimization tool, through regular polling of the connection, will have identified the failure of both MPLS links for the region and therefore have automatically rerouted the client laptop to connect to a VPN appliance in the Chennai region that still has at least one functioning MPLS link. Accordingly, the client laptop can maintain access to any remote programs or resources through the Chennai's healthy MPLS links.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for routing virtual private network (VPN) sessions, the method comprising:
providing a computer network data center comprising a plurality of zones, each zone comprising a VPN connections optimization tool and one or more VPN appliances operable to securely connect a VPN client to the data center,
wherein each zone is connected to one or more remote resources by a multiprotocol label switching (MPLS) link;
wherein the VPN connections optimization tool at a first zone is operable to perform the steps of:
periodically polling availability of a first zone's MPLS link;
receiving a threshold number of consecutive network down responses in response to the periodic polling; and
subsequently initiating a VPN connections failover process.

2. The computerized method of claim 1, wherein the VPN connections failover process comprises logging into the one or more VPN appliances at the first zone and disabling an external interface thereof using the VPN connections optimization tool at the first zone.

3. The computerized method of claim 2, wherein the disabling step triggers the VPN clients connected to the one or more VPN appliances at the first zone to reconnect to a second VPN appliance connected to the one or more remote resources via an internet connection.

4. The computerized method of claim 3, wherein the second VPN appliance is in a second zone in the computer network data center.

5. The computerized method of claim 4, wherein the one or more VPN appliances at the first zone connect to the second VPN appliance in the second zone via an MPLS connection.

6. The computerized method of claim 3, wherein the second VPN appliance is in a zone in a second computer network data center.

7. The computerized method of claim 6, wherein the one or more VPN appliances at the first zone connect to the second VPN appliance in the zone in the second computer network data center via an internet connection.

8. The computerized method of claim 1, wherein the periodically polling step occurs every 15 seconds or less.

9. The computerized method of claim 8, wherein the threshold number of consecutive network down responses comprises at least 6.

10. The computerized method of claim 1, wherein the computer network data center is one of a plurality of computer network data centers located at a plurality of geographically distributed sites.

11. A computer system for routing virtual private network (VPN) sessions, the system comprising a computer network data center comprising a plurality of zones,
wherein each zone comprises a VPN connections optimization tool and one or more VPN appliances operable to securely connect VPN clients to the data center,
wherein each zone is connected to one or more remote resources by a different multiprotocol label switching (MPLS) link; and
wherein the VPN connections optimization tool at a first zone is operable to perform the steps of:
periodically polling the first zone's MPLS link's availability;
receiving a threshold number of consecutive network down responses in response to the periodic polling; and
subsequently initiating a VPN connections failover process after the receiving step.

12. The computer system of claim 11, wherein the VPN connections failover process comprises logging into the one or more VPN appliances at the first zone and disabling an external interface thereof using the VPN connections optimization tool at the first zone.

13. The computer system of claim 12, wherein the disabling step triggers the VPN clients connected to the one or more VPN appliances at the first zone to reconnect to a second VPN appliance connected to the one or more remote resources via an internet connection.

14. The computer system of claim 13, wherein the second VPN appliance is in a second zone in the computer network data center.

15. The computer system of claim 14, wherein the one or more VPN appliances at the first zone connect to the second VPN appliance in the second zone via an MPLS connection.

16. The computer system of claim 13, wherein the second VPN appliance is in a zone in a second computer network data center.

17. The computer system of claim 16, wherein the one or more VPN appliances at the first zone connect to the second VPN appliance in the zone in the second computer network data center via an internet connection.

18. The computer system of claim 11, wherein the periodically polling step occurs every 15 seconds or less.

19. The computer system of claim 18, wherein the threshold number of consecutive network down responses comprises at least 6.

20. The computer system of claim 11, wherein the computer network data center is one of a plurality of computer network data centers located at a plurality of geographically distributed sites.
